(19) United States
(12) Patent Application Publication
(10) Pub. No.: US 2003/0074109 A1
(43) Pub. Date: Apr. 17, 2003

(54) Automatic control system using power line communication method

(76) Inventors: Jong Min Jeong, Daejeon metropolitan city (KR); Young Goo Kang, Asan-city (KR); Chong Soo Kim, Daejeon metropolitan city (KR)

Correspondence Address: Daniel F. Drexler, 55 Griffin South Road, Bloomfield, CT, 06002, US

(21) Appl. No.: 10/155,340

(22) Filed: May 24, 2002

(30) Foreign Application Priority Data
Oct. 12, 2001 (KR) 2001-63067
Dec. 21, 2001 (KR) 2001-82400

(51) Int. Cl. G05B 15/00

(52) U.S. Cl. 700/275; 700/2

(57) ABSTRACT

Disclosed is an automatic control system using a power line communication method. The automatic control system comprises an operating module having an operating program; a power line communication module connected to the operating module; and an automatic control module connected to the power line communication module through a power line and adapted to control external appliances by means of a control signal supplied thereto from the operating module. The operating module receives and processes a signal from external appliances through the automatic control module, or generate an appliance control signal for transmission to the automatic control module, thereby implementing a low-speed power line communication together with the automatic control module through the power line communication module. The automatic control system may remotely control or monitor various electric appliances through an Internet network using a conventional power line.

### BACKGROUND OF THE INVENTION

1. Field of the Invention

The present invention relates to an automatic control system using a power line communication method, and more particularly, to an automatic control system which can use a power line as a communication medium for controlling electric or electronic appliances to interactively control various appliances connected to an automatic control module.

2. Background of the Related Art

A power line communication (hereinafter, referred to as “PLC”) refers to a new technology in which voices and data are transmitted while being carried on high frequency communication signals ranging from at least several hundreds KHz to at least several tens MHz by using power lines for supplying electric power as communication media. The application of this new technology enables home networking, power network management, appliance control, etc. Recently, a high-speed access technology using PLC and a low-speed control technology using home networking attract user's attention as the next-generation communication technology.

In the meantime, for an automatic control module included in an automatic control system for controlling external appliances through a conventional power line communication method, it was impossible to simultaneously connect a variety of external appliances with the automatic control system and control them. That is, one automatic control module could not support various types of external appliances. For example, it was only possible to separately connect a device for recognizing a switching signal, a device for recognizing an analog signal, or a device for recognizing an infrared ray signal with one automatic control module, respectively. Accordingly, there has been a problem in that it was impossible to simultaneously connect various types external appliances with the automatic control system and interactively control them.

### SUMMARY OF THE INVENTION

Accordingly, the present invention is directed to an automatic control system that substantially obviates one or more problems due to limitations and disadvantages of the related art.

An object of the present invention is to provide an automatic control system using a power line communication method in which a power line is used as a communication medium for controlling electric or electronic appliances to interactively control various appliances connected to an automatic control module.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve this objects and other advantages and in accordance with the purpose of the invention, as embodied and broadly described herein, there is provided an automatic control system using a power line communication method, comprising:

an operating module having an operating program installed therein;

a power line communication module connected to the operating module; and

an automatic control module connected to the power line communication module through a power line and adapted to control external appliances by means of a control signal supplied thereto from the operating module, the automatic control module including:

a power line communication section connected to power line communication module through the power line and adapted to transmit and receive a signal to and from the power line communication module,

a controller adapted to analyze the control signal supplied from the operating module through the power line communication section to divide the control signal into a switching signal, an analog signal and an infrared ray signal or adapted to convert a signal applied from the external appliances for transmission,

a relay output section adapted to receive the divided switching signal from the controller to transmit the received switching signal to the external appliances,

a PWM output section adapted to receive the divided analog signal from the controller to transmit the received analog signal to the external appliances,

an infrared ray signal output section adapted to receive the divided infrared ray signal from the controller to transmit the received infrared ray signal to the external appliances,

a digital signal input section adapted to receive a digital signal from the external appliances, and

an analog signal input section adapted to receive an analog signal from the external appliances,

the operating module being adapted to receive and process the converted signal from the controller of the automatic control module, or generate an appliance control signal for transmission to the automatic control module, thereby implementing a low-speed power line communication together with the automatic control module through the power line communication module.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram of an automatic control system according to an embodiment of the present invention; and

FIG.2 illustrates a block diagram of an automatic control module according to an embodiment of the present invention.

### DETAILED DESCRIPTION OF INVENTION

Reference will now be made in detail to embodiments of the present invention, examples of which are illustrated in the accompanying drawings.

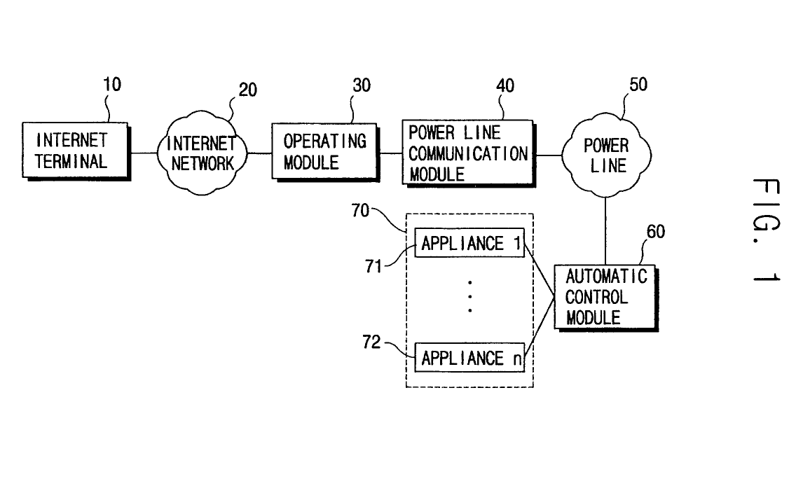

FIG. 1 illustrates a block diagram of an automatic control system according to an embodiment of the present invention.

Referring to FIG. 1, there is shown the automatic control system including an Internet terminal 10, an operating module 30, a power line communication module 40 and an automatic control module 60. The Internet terminal 10 and the operating module 30 are connected to each other, and the power line communication module 40 and the automatic control module 60 are connected to each other. Also connected to the automatic control module 60 are various types of external appliances 70.

An example of the Internet terminal 10 includes, but is particularly not limited to, a personal computer, personal digital assistances or the like that can be connected to the Internet network 20.

The operating module 30 has an operating program installed therein, which functions to receive and process a signal generated from the external appliances 70, or generate an appliance control signal to implement a low-speed power line communication together with the automatic control module 60. That is, the operating program analyzes the state of the external appliances based on the signal generated from the external appliances, and then generate a control signal for controlling the operational state of the external appliances in response to the analyzed result. Also, the operating module 30 functions to permit the Internet terminal 10 connected thereto through the Internet network 20 to remotely control the external appliances 70. Namely, the Internet terminal 10 accesses the operating module 30 to control the external appliances 70 according to the operating program installed in the operating module 30. At this time, the operating module 30 acts as a kind of server.

The power line communication module 40 is a module for transmitting a signal using the power line 50, which is a general power network installed to supply electric power.

The automatic control module 60 is a module for substantially controlling various types of external appliances 70. That is, the automatic control module 60 receives and processes a control signal transmitted from the operating module 30 through the power line communication module 40 to send a control command to the external appliances 70, and then receives a signal representing the state of the external appliances 70 to send the received signal to the operating module 40.

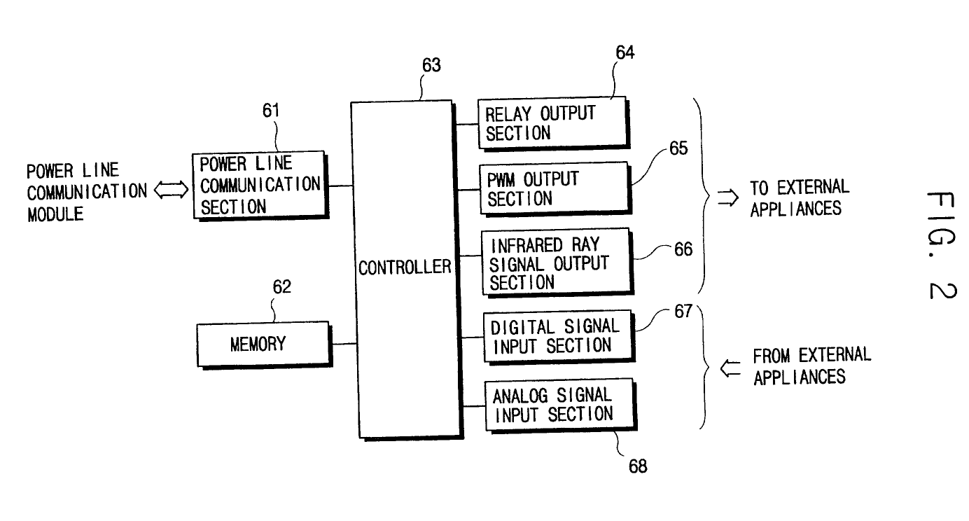

FIG.2 illustrates a block diagram of an automatic control module according to the preferred embodiment of the present invention.

Referring to FIG. 2, there is shown the automatic control module including a power line communication section 61, a memory 62, a controller 63, a relay output section 64, a PWM output section 65, an infrared ray signal output section 66, a digital signal input section 67 and an analog signal input section 68.

First, the power line communication section 61 is connected to power line communication module 40 through the power line 50 to transmit and receive a signal to and from the power line communication module 40. The controller 63 analyzes a control signal applied from the operating module 30 through the power line communication section 61 and divides the control signal into a switching signal, an analog signal and an infrared ray signal for application to the relay output section 64, the PWM output section 65 and the infrared ray signal output section 66, respectively, or converts a signal received from the external appliances 70.

The relay output section 64 receives the divided switching signal from the controller 63 to transmit the received switching signal to switching signal input sections of the external appliances 70. The PWM output section 65 receives the divided analog signal from the controller 63 to transmit the received analog signal to analog signal input sections of the external appliances 70. The infrared ray signal output section 66 receives the divided infrared ray signal from the controller 63 to transmit the received infrared ray signal to infrared ray signal input section of the external appliances 70.

The digital signal input section 67 receives a digital signal from the external appliances 70, and the analog signal input section 68 receives an analog signal from the external appliances 70.

In the meantime, the memory 62 stores a control signal for controlling the external appliances 70. The controller 63 controls the external appliances 70 in such a fashion that a programmable logic controller (PLC) directly controls the external appliances 70 on the spot where they are installed by using the control signal stored in the memory 62 without receiving a separate control signal from an external operating module 30. If the various types of external appliances 70 are connected to the automatic control module 60 together, a communication network between the external appliances can be implemented. At this time, when the control signal is stored in the memory 62 in such a fashion that the sequence by the external appliances is determined, it is possible to sequentially control the external appliances 70.

As described above, according to the present invention, it is possible to remotely control or monitor various electric appliances through an Internet network without a limitation on time and space by using a conventional power line, thereby reducing a cost required to additionally install communication lines. Moreover, a communication network between the external appliances is implemented so that a use efficiency of the appliances can be increased, and the external appliances are remotely controlled so that a risk according to the use of the appliances can be decreased.

The forgoing embodiments are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. An automatic control system using a power line communication method, comprising:
an operating module having an operating program installed therein;
a power line communication module connected to the operating module; and
an automatic control module connected to the power line communication module through a power line and adapted to control external appliances by means of a control signal supplied thereto from the operating module, the automatic control module including
a power line communication section connected to the power line communication module through the power line and adapted to transmit and receive a signal to and from the power line communication module,
a controller adapted to analyze the control signal supplied from the operating module through the power line communication section to divide the control signal into a switching signal, an analog signal and an infrared ray signal or adapted to convert a signal applied from the external appliances for transmission,
a relay output section adapted to receive the divided switching signal from the controller to transmit the received switching signal to the external appliances,
a PWM output section adapted to receive the divided analog signal from the controller to transmit the received analog signal to the external appliances,
an infrared ray signal output section adapted to receive the divided infrared ray signal from the controller to transmit the received infrared ray signal to the external appliances,
a digital signal input section adapted to receive a digital signal from the external appliances, and
an analog signal input section adapted to receive an analog signal from the external appliances,
the operating module being adapted to receive and process the converted signal from the controller of the automatic control module, or generate an appliance control signal for transmission to the automatic control module, thereby implementing a lowspeed power line communication together with the automatic control module through the power line communication module.

2. The automatic control system according to claim 1, wherein the automatic control module further includes a memory adapted to store the control signal for controlling the external appliances therein so that the stored control signal controls the external appliances.

3. The automatic control system according to claim 1, wherein an Internet terminal connected to the operating module through an Internet network remotely controls the external appliances.
